(19) United States
(12) Patent Application Publication
(10) Pub. No.: US 2026/0087750 A1
(43) Pub. Date: Mar. 26, 2026

(54) DISPLAY PRESENTATION ON AN IMMERSIVE DEVICE

(71) Applicant: Lenovo (United States) Inc., Morrisville, NC (US)

(72) Inventors: Mengnan Wang, Durham, NC (US); John W. Nicholson, Cary, NC (US)

(21) Appl. No.: 18/898,000

(22) Filed: Sep. 26, 2024

(51) Int. Cl. G06T 19/00; G06F 3/01

(52) U.S. Cl. CPC G06T 19/006; G06F 3/012; G06F 3/013; G06T 2210/62

(57) ABSTRACT

One embodiment provides a method, the method including: receiving, at an immersive device, display information related to information being displayed on a device display that is within an environment being viewed through a display of the immersive device; displaying, on the display of the immersive device, video corresponding to the environment, wherein the displaying includes generating an overlay for the device display containing the information being displayed and positioning the overlay on the display of the immersive device at a location corresponding to a location of the device within the environment; and updating, the display on the immersive device, the overlay for the device display in real-time based upon information on the device display and characteristics of the device. Other aspects are claimed and described.

### BACKGROUND

Immersive devices (e.g., virtual reality devices, augmented reality devices, mixed reality devices, etc.) allow a user to view virtual elements through an immersive device display. Immersive device displays can include headsets, displays on a handheld device, glasses, and/or the like. In an immersive environment, the user views the immersive device display and is presented with an environment that makes the user feel like they are in the virtual environment and also allows the user to interact with the environment, even if that only includes just moving through the environment. While virtual reality devices create environments from completely virtual elements, other immersive devices create environments that include both virtual elements and real-world elements. For example, augmented reality devices may display virtual elements over the top of the real-world elements. These environments may allow the user to continue to interact with the real world while presenting the user virtual elements that may supplement the real-world elements. For example, using an augmented reality device in a furniture store may result in a user being able to see the furniture and the device to present specifications and costs of the furniture that the user is viewing on the display.

### BRIEF SUMMARY

In summary, one aspect provides a method, the method including: receiving, at an immersive device, display information related to information being displayed on a device display that is within an environment being viewed through a display of the immersive device; displaying, on the display of the immersive device, video corresponding to the environment, wherein the displaying includes generating an overlay for the device display containing the information being displayed and positioning the overlay on the display of the immersive device at a location corresponding to a location of the device within the environment; and updating, the display on the immersive device, the overlay for the device display in real-time based upon information on the device display and characteristics of the device.

Another aspect provides a system, the system including: an immersive device including a display; a device display of a device; a processor; a memory device that stores instructions that, when executed by the processor, causes the system to: receive, at the immersive device, display information related to information being displayed on the device display that is within an environment being viewed through the display of the immersive device; display, on the display of the immersive device, video corresponding to the environment, wherein the displaying includes generating an overlay for the device display containing the information being displayed and positioning the overlay on the display of the immersive device at a location corresponding to a location of the device within the environment; and update, the display on the immersive device, the overlay for the device display in real-time based upon information on the device display and characteristics of the device.

A further aspect provides a product, the product including: a computer-readable storage device that stores executable code that, when executed by a processor, causes the product to: receive, at an immersive device, display information related to information being displayed on a device display that is within an environment being viewed through a display of the immersive device; display, on the display of the immersive device, video corresponding to the environment, wherein the displaying includes generating an overlay for the device display containing the information being displayed and positioning the overlay on the display of the immersive device at a location corresponding to a location of the device within the environment; and update, the display on the immersive device, the overlay for the device display in real-time based upon information on the device display and characteristics of the device.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for generating and displaying an overlay on an immersive device when viewing of a device display through the immersive device utilizing and updating the overlay in real-time based upon the information being displayed on the device display and characteristics of the device.

FIG. 4 illustrates a device display including artefacts as viewed through a display of a conventional immersive device.

FIG. 5 illustrates the device display as viewed through a display of the described immersive device.

### DETAILED DESCRIPTION

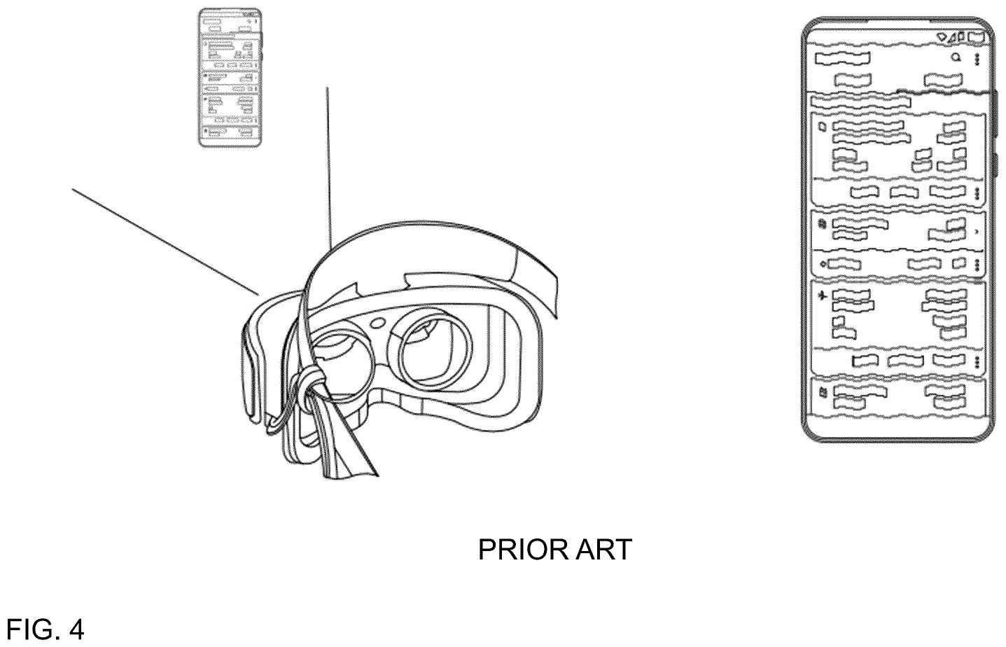

While some immersive devices types allow for the viewing of the real world through or within the display, these devices can suffer from some issues, particularly, when viewing other displays through the immersive device display. Sometimes when viewing other displays through the immersive device display, artefacts will appear on the immersive device display over the device. In other words, when the user is viewing the device display through the immersive device display, the device display will appear distorted, for example, with black lines, blocky graphics, blurred graphics, and/or the like, for example as illustrated in FIG. 4. The left portion of FIG. 4 illustrates what the immersive device is seeing with respect to a device within the environment. The right portion of FIG. 4 illustrates what the user might see through the headset display in relation to the device. This is due to a relationship between the refresh rate and the shutter speed. When the refresh rate is increased and the shutter speed is reduced, the immersive device is able to capture the refresh of the device display, resulting in the distorted display. This is particularly prominent when in a bright environment.

Similarly, a dim environment will cause problems with the display of the device display through the immersive device display. Due to the dimness of the environment, the image capture sensors and devices of the immersive display will adjust to account for this dimness. However, since the image capture sensors all have to be adjusted similarly, the exposure is set too long. Thus, the bright screen of the device display does not need an exposure set that long. Accordingly, the device display ends up overexposed when viewed through the immersive device display. Thus, in both of these situations, the device display is inaccurately viewed through the immersive device display due to the fact that a display is being viewed through another display.

One solution is to improve the camera high dynamic range (HDR). High dynamic range allows a system to capture bright and dim spots in the same image by capturing multiple images of the same scene with different shutter speeds. These images are then stitched together to create a single image of the scene with details of both bright an dim spots. This increases the amount of time needed to create an image, which could cause a lag on the immersive device display. Additionally, device displays may not be accurately identified as part of a scene that needs to a different shutter speed. Thus, when the images are stitched, the merged result might still include artefacts or overexposure on the device display. Additionally, because the creation of two separate images for the same scene takes time, something can move between the two separate images, thereby creating misalignment in the rendered image. Finally, for head mounted devices, the pass-through video is mostly captured from fixed focal, fixed aperture cameras, so it is difficult for it to capture HDR.

Another solution is to create a virtual screen on the immersive device display that corresponds to the device display. However, this window is placed at a stationary location on the immersive device display. In other words, the user no longer views the device display through the immersive device display, but rather views the device display in some other location on the immersive device display. This requires learning by the user in order to become used to utilizing the device while viewing it at a different location on the immersive device display. In other words, this can be troublesome to learn to use efficiently and effectively.

Accordingly, the described system and method provides for generating and displaying an overlay on an immersive device when viewing of a device display through the immersive device utilizing and updating the overlay in real-time based upon the information being displayed on the device display and characteristics of the device. The immersive device receives display information related to information being displayed on a device display that is within an environment being viewed through a display of the immersive device. For ease of readability, the device display will be referred to as a smart phone display and the immersive device will be referred to as an augmented reality headset or headset. However, these are merely illustrative examples as any type of display (e.g., smart phone display, display, monitor, smart television, television, liquid crystal display (LCD) screen, smart watch, digital watch, etc.) may be utilized and any type of immersive device (e.g., augmented reality device, mixed reality device, virtual reality device, etc.) may be utilized.

The headset displays video corresponding to the environment. Within this video, the headset generates an overlay for the smart phone display that contains the information being displayed on the smart phone display. The overlay is positioned at a location on the display of the headset so as to coincide with the location of the smart phone in the real world. In other words, with the user viewing the headset display, the overlay covers the smart phone. The overlay is positioned to match the smart phone display so that there does not appear to be an overlay to the user. In other words, to the user, it looks like the user is viewing the display of the smart phone and not a video of the display of the smart phone.

The system updates the overlay for the smart phone display in real-time based upon the information being displayed on the smart phone and characteristics of the device. The characteristics of the device include a position of the device display in the environment, an angle of the device display with respect to the gaze of the user, and/or the like. In other words, the characteristics include any characteristics of the physical position of the smart phone that would affect how the display is seen by the user in the real world and would, therefore, affect how the overlay is created to make the overlay “invisible” to the user.

Therefore, a system provides a technical improvement over traditional methods for displaying device displays on an immersive device. Instead of requiring the immersive device to correctly identify that a device display may need a different shutter speed than other portions of the scene, the immersive device creates an overlay of the device display for presentation on the immersive device display. This solves the problem of artefacts over the device display or the device display being overexposed.

Additionally, since the device display is anchored to the device within the immersive device display, the user can utilize the device just as the user normally uses the device. In other words, even though a virtual screen is being created by the immersive device for display on the immersive device display, as far as viewing and use, the user cannot tell the difference between use of the device with and without the immersive device because it appears to the user that they can see the device display through the immersive device display. Accordingly, the system and method provide a solution to create a more usable immersive experience for the user.

The illustrated example embodiments will be best understood by reference to the figures. The following description is intended only by way of example, and simply illustrates certain example embodiments.

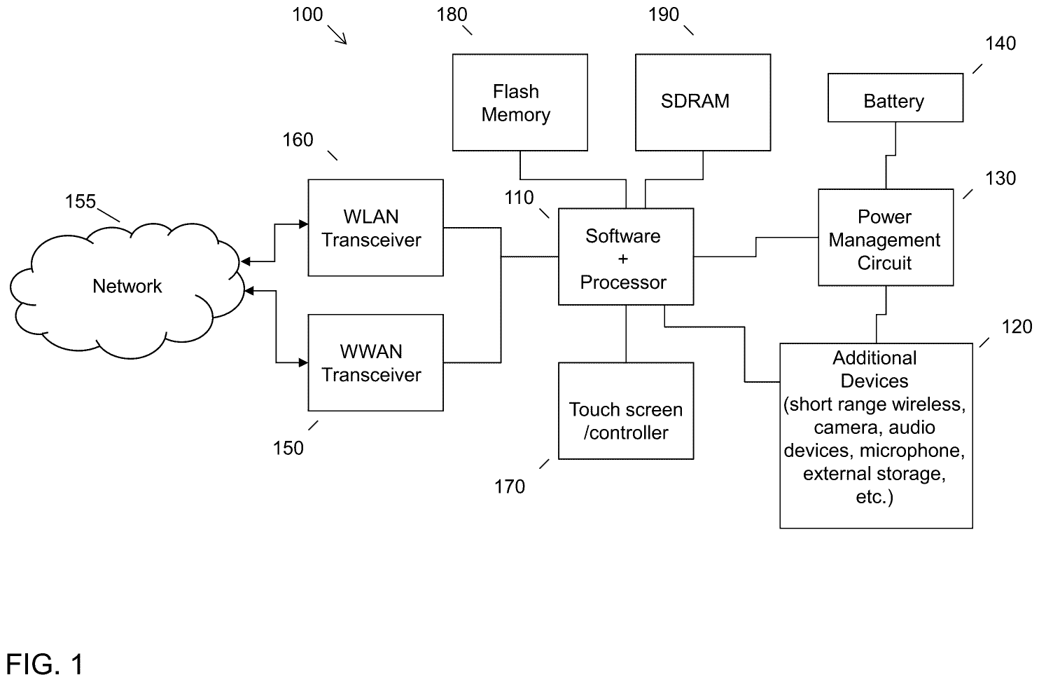

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

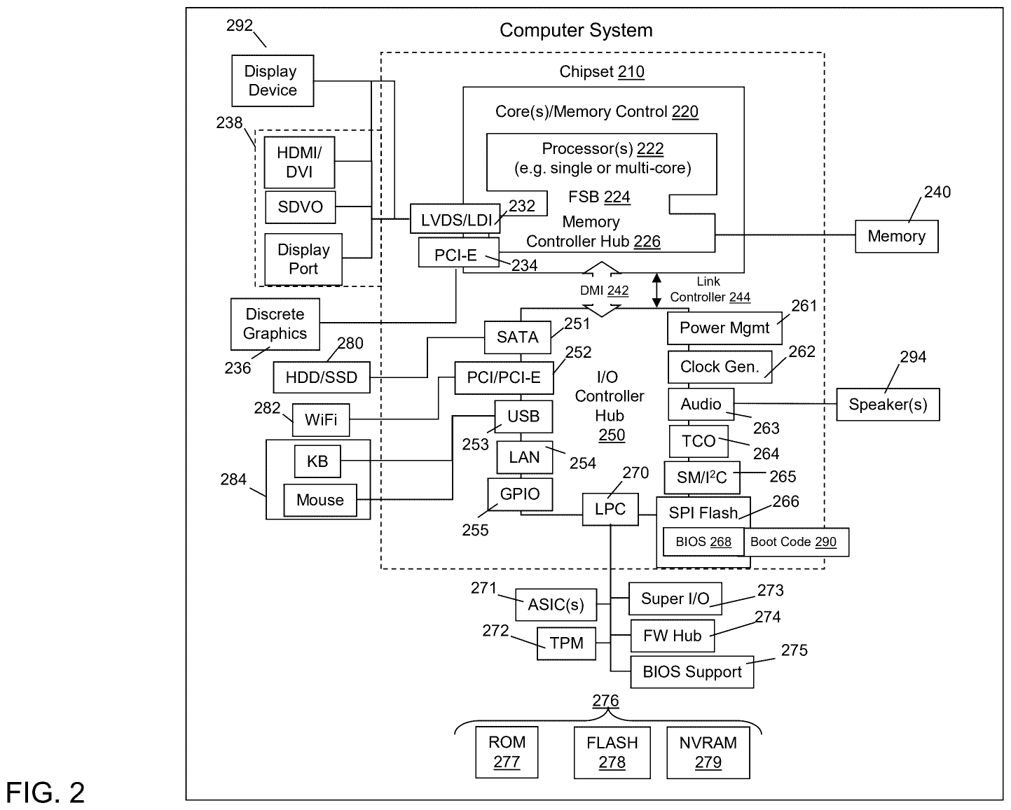

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used as immersive devices or may be used to support immersive devices. For example, the circuitry outlined in FIG. 1 may be implemented in a tablet or smart phone embodiment, whereas the circuitry outlined in FIG. 2 may be implemented in a personal computer embodiment.

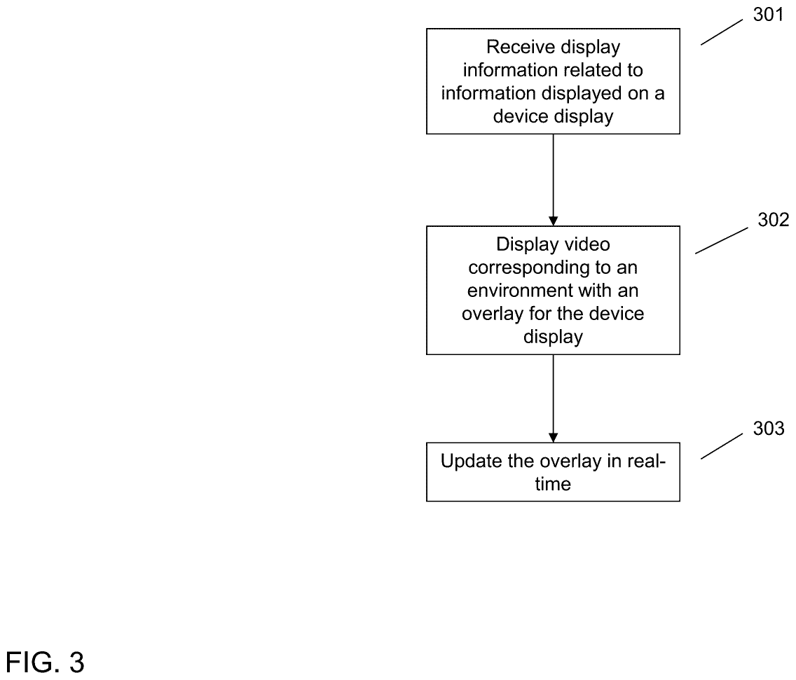

FIG. 3 illustrates an example method for generating and displaying an overlay on an immersive device when viewing of a device display through the immersive device utilizing and updating the overlay in real-time based upon the information being displayed on the device display and characteristics of the device. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to generate and display an overlay for a device display on an immersive device. Additionally, the immersive device overlay generation system includes modules and features that are unique to the described system.

Activation of the immersive device overlay generation system may be a manual activation of the immersive device overlay generation system and/or an automatic activation of the immersive device overlay generation system. Manual activation of the system may include a user turning on the immersive device, activating the display of the immersive device, opening an application to start the immersive device display, and/or the user otherwise providing input to the immersive device overlay generation system. The automatic activation of the immersive device overlay generation system may be based upon the detection of a trigger event indicating that the system should be activated. Example trigger events include a user viewing a device display, detection of a user expressing frustration with the viewing of a device display, detecting light characteristics in the environment that would cause issues with viewing the device display through the immersive device display, and/or the like.

The immersive device overlay generation system may be made of multiple systems or modules that communicate together to make up the immersive device overlay generation system or may be a single system. The immersive device overlay generation system may be a standalone system, may be accessible through other computing devices, and/or a combination thereof. For example, the immersive device overlay generation system may be a standalone system that can be accessed by a user and/or may be or provide an application that is accessible by a user on another computing device. The immersive device overlay generation system may be accessible using any type of computing device, for example, personal computer, laptop computer, smartphone, tablet, smartwatch, head-mounted display, smart television or other smart appliance, augmented reality device, virtual reality device, and/or the like.

Thus, the immersive device overlay generation system may be accessible locally using a computing device where the immersive device overlay generation system is installed and/or may be accessible remotely through another computing device. For example, the immersive device overlay generation system may be accessed by a user using a device that communicates with the immersive device overlay generation system. However, the immersive device overlay generation system may be located and operate on a different information handling device as compared to the device being utilized by the user to perform the described steps.

The generation and display of overlays on an immersive device display can be provided as a service to other entities or companies. In other words, the immersive device overlay generation system could be stored on a server or network of a company and the system could receive display information related to information being displayed on a device display, generate overlays for the device information, and then provide instructions for displaying the overlay on the immersive device display, with the other companies or entities paying for the generation of overlays or other use of the immersive device overlay generation system.

The immersive device overlay generation system may have an associated graphical user interface that is different than what is displayed on the immersive device display. The graphical user interface may be provided on a display or monitor, which may or may not be associated with the immersive device overlay generation system. In other words, the immersive device overlay generation system may have a dedicated display or monitor or may be accessible using any display or monitor. In either case, the immersive device overlay generation system may provide instructions to generate and display the graphical user interface on the display device being used to access the immersive device overlay generation system. The graphical user interface may also be updated and managed based upon instructions provided by the immersive device overlay generation system. In other words, the immersive device overlay generation system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the immersive device overlay generation system. For example, the immersive device overlay generation system may utilize a user profile, device profile, and/or the like, to identify user preferences and how overlays should be generated and presented for different devices and/or immersive devices, and/or the like. The graphical user interface may allow for creation of or access to these profiles, historical information, and/or the like, by allowing a user to input information regarding user preferences, device preferences, and/or the like. As will be discussed in more detail, the use of user provided information is not the only way that the profile and/or historical information can be created. The immersive device overlay generation system can then utilize these inputs to create the profile(s), store the historical information, identify when and how overlays should be generated and displayed, and/or the like.

A user could also use the graphical user interface to adjust information within the profile(s), historical information, and/or the like. Additionally, or alternatively, the user can input a location of information related to one or more of the profiles, historical information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display information of the profiles, information of devices or immersive devices, and/or the like. It should be noted that the information to be used by the immersive device overlay generation system and information provided by the immersive device overlay generation system can be different for different applications, different computing systems, different users, and/or the like. Thus, the information corresponding to input or output of the immersive device overlay generation system are not always the same. However, the immersive device overlay generation system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The immersive device overlay generation system may utilize one or more artificial intelligence models in generating and updating an overlay for the immersive device display. Artificial intelligence models could be designed to generate an overlay, update the overlay in real-time, or any other steps within the described system. Artificial intelligence models may also be used for steps within a step. For example, a model could be utilized to analyze sensors inputs to determine how to position the overlay on the display of the immersive device, identify objects within the scene to generate the overlay, stitch together portions of images to create a video for display on the immersive device display, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the immersive device overlay generation system or may be a model that is created from scratch. Since the immersive device overlay generation system is used in conjunction with generating an overlay and displaying and updating the overlay on an immersive device display, some models that may be utilized by the system are image analysis models, audio analysis models, other analysis models, object identification models, entity identification models, similarity identification models, language models, large language models, filtering models, classification models, and/or the like. The model may be trained using one or more training datasets.

Additionally, as the model is deployed, it may receive feedback to become more accurate over time. The feedback may be automatically ingested by the model as it is deployed, may be stored for subsequent training, may be stored in a data storage location to be accessed by the model for subsequent predictions, and/or the like. For example, as the model is used to perform the described method, if a user modifies predictions that were made by the model, provides feedback regarding a prediction, or otherwise provides some indication that the predictions or selections made by the model may be incorrect, the feedback can be utilized to better train the model, be placed into a data storage location accessible and usable by the model, or otherwise used to improve the accuracy of the model.

On the other hand, as the model makes predictions in connection with performing the described steps, and no changes are made to the resulting prediction, the model system may also utilize this as feedback to make the model better. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The immersive device overlay generation system may include different components for carrying out different functions of the system, including different steps to be performed. These components may be hardware components or software components. Some hardware devices or components that may be utilized by the immersive device overlay generation system include input devices that may be utilized to receive input from the user, for example, mechanical input modalities (e.g., keyboard, mouse, etc.), touch input devices, gesture input devices, electromyography input devices, audio input devices, image capture devices, and/or the like. Other hardware components may be utilized to provide output from the immersive device overlay generation system. For example, the immersive device overlay generation system may include speakers, displays or monitors, haptic output devices, audio output devices, and/or the like. Other hardware components may be included.

One software component includes the user profile that stores information related to the user and user preferences. The user profile may be unique to a user and may assist in determining how the system should generate and display overlays, how and when overlays should be updated, and/or the like. The user profile may include user preferences. For example, the user may identify whether obstructions between the device display and the immersive device display will be ignored or reflected within the overlay, whether shadows, reflections, and other environmental light characteristics will be reflected or ignored within the overlay, and/or the like. The user profile may also identify different devices or device types and differences between the treatment of those displays related to the viewing of those displays through the immersive device display. The user profile may also include other information about the user that seems to influence overlay generation and display, for example, a device that the user is using during different sessions, a location where the user is located when overlays are generated, displayed, and updated, light characteristics of the environment when overlays are generated, displayed, and updated, and/or the like.

The user may manually input data into the profile or the information within the profile may be populated by the system as the system learns about the user over time. For example, the system may utilize an artificial intelligence model to learn about the user, make correlations between information received about the user and the generation of overlays and the display thereof, and/or the like. This information can be populated within the user profile for use by the system during subsequent immersive device sessions.

At 301, the immersive device receives display information related to information being displayed on a device display that is within an environment being viewed through a display of the immersive display. In other words, a user is utilizing an immersive device and is viewing another display through the display of the immersive device. For ease of readability, the example of an immersive device headset will be utilized for the immersive device. Additionally, the example of a smart phone will be utilized for the device being viewed through the headset. However, it should be noted, these are non-limiting examples, and different immersive devices and devices can be utilized. Additionally, the example of an augmented reality device will be utilized for the immersive device. However, different types of immersive devices can be utilized.

The headset and smart phone may be connected together in a manner that allows them to communicate with each other. For example, the headset and smart phone may be communicatively connected via a wireless connection (e.g., near-field communication connection, short-range communication connection, network communication connection, etc.), a wired connection, and/or the like. To communicatively connect the headset and smart phone, the devices may perform a pairing function, the devices may be visible to each other due to connection to the same network, one device may display a code (e.g., numerical or character code, quick read (QR) code, bar code, etc.) that is read by or entered into the other device, and/or the like.

Once the devices are communicatively connected, the smart phone and headset can transmit information between each other. This connection allows the smart phone to transmit information to the headset including information identifying what is currently displayed on the smart phone display. Thus, receiving the display information may include receiving the display information directly from the smart phone. However, other techniques for receiving the display information are contemplated and possible. For example, the headset could receive the display information from other sensors or components within the environment. If the environment has other image capture devices or sensors, these image capture devices or sensors could capture images of the smart phone display and transmit this information to the headset. As another example, the headset could capture the display information itself through the use of image capture sensors located on the headset, located near the headset, or otherwise connected to or accessible by the headset.

Once the display information is received at the immersive device overlay generation system (which may be simply the headset and components thereupon or may include other components which may not be located at or on the headset), which may include receipt directly at the headset, the system may analyze the information so that it can be duplicated or reproduced at the headset. Thus, the system may utilize information analysis techniques to identify the information and objects within the display information. Alternatively, or additionally, the system may perform no analysis regarding the information contained on the display of the smart phone, and may, instead, simply copy the information from the display information.

In addition to receiving the display information, the immersive device overlay generation system may also identify a location and position of the smart phone within the environment. This identification of the location and position may also include identifying the location and position of the smart phone with respect to a gaze of the user and the location and position of the head of the user. In other words, the system identifies a location and position of the smart phone within the environment and with respect to a user or the headset. The location and position information may be received from the smart phone. For example, the smart phone may utilize sensors that allow the smart phone to know its position within the environment and with respect to the user. These sensors may include, but are not limited to, accelerometers, gyroscopes, proximity sensors, image capture sensors, capacitive sensors, and/or the like. The sensor information can then be transmitted to the headset or immersive device overlay generation system.

In addition to, or instead of, inputs being identified by the smart phone, other devices or sensors within the environment could also capture information or inputs to assist in determining the location and position of the smart phone within the environment. For example, image capture devices within the environment could be used to identify a location and position of the smart phone. As another example, if the environment includes any weight sensors, the weight sensors could be utilized to determine a location of the user within the environment which could assist in identifying a location of the device within the environment. As a final, non-limiting example, if the environment includes proximity sensors, the proximity sensors could be utilized to determine a location of the user or smart phone within the environment. It should be readily understood that other sensors and devices could be utilized to assist in determining a location and position of the user and/or smart phone within the environment. Additionally, the headset itself can capture information that helps identify a location and position of the smart phone in the environment. For example, the headset may utilize gaze tracking and other sensors of the headset to detect a location of the head of the user with respect to the location of the device within the environment.

The system and/or headset is trying to determine the location and position of the smart phone with respect to how a user is viewing the smart phone through the headset display. Thus, any information that can be received from the smart phone, identified by the headset, received from other devices or sensors within the environment, and/or the like, that can assist in identifying this location and position, can be captured and transmitted to the immersive device overlay generation system. Once the system and/or headset captures inputs itself and/or receives any inputs from other devices, including the smart phone, the system and/or headset can analyze these inputs to determine a location and position of the smart phone within the environment. For example, the immersive device overlay generation system can utilize object recognition analysis techniques to determine a location and position of the smart phone within the environment.

At 302, the immersive device overlay generation system displays, on the display of the headset, video corresponding to the environment. In other words, the headset provides the immersive experience on the display of the headset. Within the video, the headset generates an overlay for the smart phone display that contains the information that is being displayed on the smart phone display. In other words, within the video, the display information that was received at 301 is duplicated on the headset display. Stated differently, within the video presented on the headset display is the exact information that is currently being displayed on the smart phone display. The headset integrates the display information into the pass-through video feed captured by the image capture sensors and devices of the headset.

It should be noted that while the immersive device overlay generation system could generate the video for any displays that are detected within the field of view of the user, in order to conserve processing power and other resources, the immersive device overlay generation system may only generate the video for displays based upon certain conditions. For example, the video may only be generated for displays that are directly being viewed by the user. As an example, if the user is in an environment that has many different displays, but the user is only directly looking at or utilizing displays directly in front of the user, the system may not generate the video overlay for the devices that the user is not looking at or utilizing. As another example, the video overlay may only be generated for displays that have been designated by the user, that are associated with or assigned to the user, and/or the like. This information could be contained within the user profile.

As another example, the video overlay may only be generated when the immersive device overlay generation system detects light conditions that would or that do affect the viewability of the smart phone display through the display of the headset. In other words, generating the overlay may only be responsive to detecting light conditions affecting a viewability of the device display through the display of the immersive device. In this case, the immersive device overlay generation system is detecting light conditions which would cause the artefacts, overexposure, or other defects to be seen by the user when viewing the smart phone display through the headset display. Accordingly, the light conditions detected may include light conditions within the environment such as dim lighting, bright lighting, and/or the like. Thus, the system could utilize sensors or components that can perform this detection. The system may then activate the video overlay generation when the light conditions meet or exceed a predetermined threshold, for example, when the brightness of the environment meets or exceeds a predetermined threshold, when the dimness of the environment meets or exceeds a predetermined threshold, and/or the like.

Additionally, due to the detected light conditions, the headset modifies characteristics of the image capture sensors located on the headset. Thus, instead of, or in addition to, directly detecting the light conditions for the video overlay generation, the system may instead determine that the characteristic of the image capture sensors has met or exceeded a predetermined threshold. Some characteristics of the image capture sensors that may be modified and thereafter detected include, but are not limited to, exposure length, shutter speed (which is generally a function of exposure length), focus, focal ratio, and/or the like. Thus, if one or more of these characteristics is adjusted by the headset to a value or setting that meets or exceeds a predetermined threshold, the immersive device overlay generation system may activate the overlay generation. The predetermined threshold may be a threshold value where the system recognizes that the artefacts, overexposure, and/or other defects, could be presented on the headset display with respect to the smart phone display.

Additionally, or alternatively, the system could analyze images that have been captured by the headset and identify characteristics of the images that would indicate the overlay generation should be activated. For example, if an image has dim and bright portions, the system may determine that the overlay generation should be activated. As another example, if the system detects artefacts, overexposure, or other defects within the image, the system may determine that the overlay generation should be activated. Additionally, or alternatively, the system could monitor the user and, based upon input by the user, the system could determine that the overlay generation should be activated. For example, the user could provide a gesture input indicating the overlay generation should be activated, the system could detect frustration from the user regarding the use of a device with the headset and could then activate the overlay generation, the user could provide a manual input to activate the overlay generation, and/or the like. Other techniques can be utilized to activate the overlay generation, if the overlay generation is not activated upon activation of the headset.

The display information being displayed on the headset display is positioned at a location on the headset that corresponds to the location of the smart phone in the environment. In other words, the display information being displayed on the headset display is positioned such that it overlays the location of the smart phone. Thus, from the perspective of the user, it appears that the user is looking at the smart phone display and not a video or reproduction of the smart phone display. Stated differently, the overlay is positioned at a location on the display of the headset so as to coincide with the location of the smart phone in the real world. The overlay is positioned and aligned to match the smart phone display so that there does not appear to be an overlay to the user. Additionally, the overlay is anchored to the location and position of the smart phone within the environment. Thus, when the smart phone is moved, the overlay is adjusted to match the new location and position of the smart phone, thereby providing a seamless immersive experience to the user such that, from the perspective of the user, it appears that the user is looking directly at the smart phone display through the headset display, but without the artefacts, overexposure, or other defects that can be caused by viewing a device display through an immersive device display.

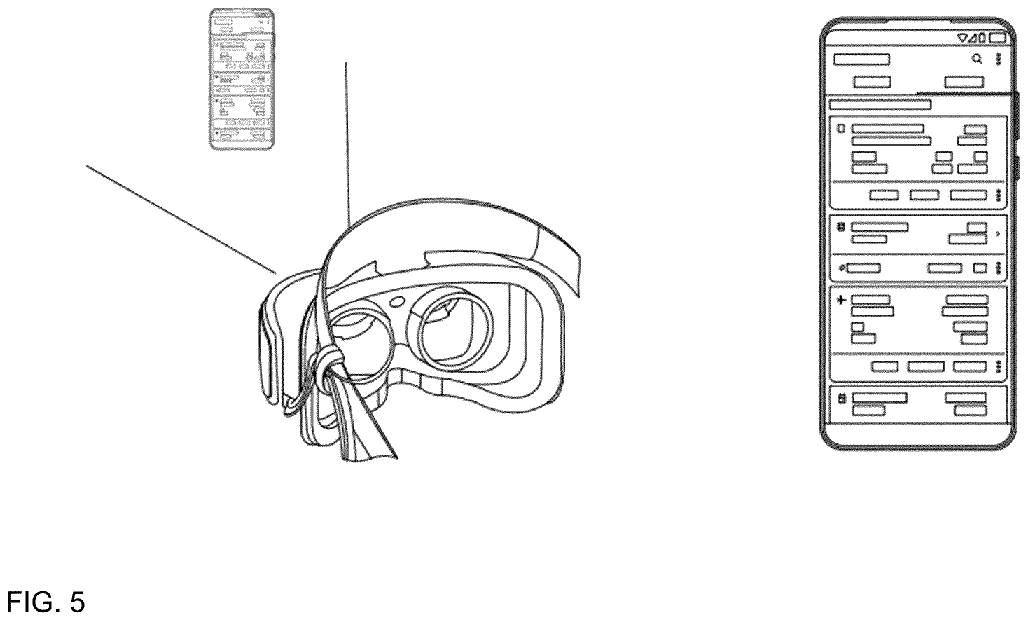

Accordingly, instead of what is displayed on the headset display as identified in connection with FIG. 4, the user will see what is illustrated in FIG. 5. The left portion of FIG. 5 illustrates the same field of view of the headset as illustrated in FIG. 4. However, instead of the distorted view of the device display through the headset as illustrated in the right portion of FIG. 4, the user sees that which is illustrated in the right portion of FIG. 5 through the headset display. As can be seen, what the user sees through the headset display in relation to the device display is exactly what is displayed on the device display.

To ensure that the video of the display information is aligned with the location of the device within the field of view of the user, the immersive device overlay generation system takes into account the angles of the smart phone display with respect to the head of the user, the gaze of the user with respect to the smart phone display, a distance of the smart phone with respect to the head of the user, and/or the like. Thus, the immersive device overlay generation system adjusts the aspect ratio, shape, size, and/or other characteristics of the video corresponding to the smart phone display to match what would be seen by the user as if the user were viewing the smart phone display directly through the headset display.

Once the overlay video for the smart phone display has been generated and presented on the headset display, the immersive device overlay generation system updates the overlay for the device display in real-time based upon information on the device display and characteristics of the device at 303. In other words, the immersive device overlay generation system updates the overlay for the smart phone in real-time as the display information of the smart phone changes and characteristics of the smart phone. Thus, as the information on the smart phone display changes and/or the location and position of the smart phone within the environment changes, the system updates the overlay to match this change in display information and/or change in location and position of the smart phone.

In updating the overlay, the system can utilize any of the techniques as described previously to identify the display information, identify the location and position of the smart phone within the environment, and/or generate the updated overlay. Accordingly, the system matches the overlay to the appearance of the smart phone display within the environment as the appearance (e.g., display information, location and position of the smart phone, etc.) of the smart phone changes within the environment. Thus, updating the overlay may include changing the information being displayed on the headset display, changing a size and shape of the overlay, changing an aspect ratio of the overlay, and/or the like.

In order to create a realistic overlay, the system may take into account factors within the environment that may affect the viewability of the smart phone display through the headset display. One factor may be whether there are any obstructions between the smart phone display and the headset display. Obstructions may include obstructions that are related to the user. For example, the user could be utilizing their fingers to provide input to the smart phone. However, the fingers of the user would be located between the smart phone display and the headset display. Other obstructions related to the user could include other body parts of the user, objects that the user is touching or holding (e.g., stylus, cables, other devices, sunglasses, hats, etc.), and/or the like. Additionally, other obstructions not related to the user are possible, for example, a bird or other animal, another person, other objects, and/or the like. In other words, anything that could be located between the headset display and the smart phone display is an obstruction that obscures at least a portion of the smart phone display.

Since the headset is receiving the information contained on the smart phone display from another source and not directly through the headset display, the overlay could ignore the obstruction and present the entirety of the display information within the overlay. However, this may be undesirable to the user. For example, if the user is providing input to the smart phone, if the overlay does not take into account this obstruction, the user will not be able to see their fingers or other input device through the overlay, which may make it difficult to provide the input. Accordingly, the system can detect an obstruction over the smart phone display and update the overlay to segment a portion of the overlay corresponding to the obstruction and adjust an opacity of this portion of the overlay corresponding to the obstruction. In other words, the system can detect the obstruction and then cause an opacity of a portion of the overlay corresponding to the obstruction change so that the obstruction could be seen through the overlay. The system could adjust the opacity to any value, including to be transparent. The opacity value could be adjusted based upon the type of obstruction, preferences provided by the user, and/or the like. Thus, using the example above, the user would be able to see their fingers or other input device through the overlay. This also would make the overlay match the real-world environment, making the overlay seem even more “invisible” to the user.

Another factor that the system may take into account is any light conditions that affect the viewability of the device display within the environment. Thus, instead of detecting light conditions that affect the viewability of the device display through the headset display, as explained before, in this case, the system is detecting light conditions that affect the viewability of the device display within the environment as if the user were not viewing the device display through the headset display. These light conditions may include conditions that create effects on the smart phone display, for example, shadows, light rays, light flickers, lightning, reflections, and/or the like. To make a more realistic overlay, the system could identify these effects and reproduce them on the overlay. In other words, the system could identify these light conditions or effects and update the overlay to include these light conditions or effects. Thus, the overlay would appear exactly like the smart phone display within the environment.

Whether generating and/or updating the overlay takes factors into account within the overlay may be a user-selectable preference. For example, the user may not want shadows and light rays to be viewable on the overlay. Thus, the user could toggle this setting so that such light conditions are not taken into account and presented within the overlay video. As another example, the user may not want the obstructions to be viewable through the overlay. Thus, the user could toggle this setting so that obstructions are not taken into account and presented within the overlay video. The settings may also be more granular. For example, the user may indicate that shadows should be displayed within the overlay, but light rays are to be ignore. As another example, the user may indicate obstructions related to the user (e.g., fingers, stylus, something being held or touched by the user, a body part of the user, etc.) should be viewable through the overlay, but other obstructions should not be viewable through the overlay. These user preferences could be manually input by the user, could be learned by the system over time, could be stored within the user profile, and/or the like, or a combination thereof.

As an overall non-limiting example of the described system, a user could be utilizing a tablet while donning mixed reality glasses in a bright environment. Due to the bright environment, the image capture sensors of the glasses have been adjusted, and, on the glasses display, artefacts appear over the tablet display, thus making the tablet difficult to utilize due to the appearance of the artefacts. Accordingly, the glasses create an overlay that includes the information being displayed on the tablet and displays the overlay on the glasses in a position that matches not only the location of the tablet through the glasses, but also a position of the tablet with respect to the glasses. Thus, the overlay is positioned and created to appear as if the user is looking at the tablet display and not a digital version of the tablet display. As the user interacts with the tablet, including moving the tablet or changing the information being displayed on the tablet, the overlay is updated to match these changes.

Additionally, the user has set the preferences so that obstructions related to the user are viewable through the overlay. Thus, as the user provides input to the tablet using their hand and a stylus, the glasses identify the location of the hand and stylus and segment the portion of the overlay corresponding to the hand and stylus. The glasses then change the opacity of this portion to transparent so that the user can see their hand and stylus through the overlay. However, the user has also identified that environmental light conditions that affect the viewability of the tablet within the environment should be ignored and not reproduced on the overlay. Thus, the glasses ignore any reflections, shadows, and other light effects and conditions, and do not reproduce these within the overlay.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
receiving, at an immersive device, display information related to information being displayed on a device display that is within an environment being viewed through a display of the immersive device;
displaying, on the display of the immersive device, video corresponding to the environment, wherein the displaying comprises generating an overlay for the device display containing the information being displayed and positioning the overlay on the display of the immersive device at a location corresponding to a location of the device within the environment; and
updating, the display on the immersive device, the overlay for the device display in real-time based upon information on the device display and characteristics of the device.

2. The method of claim 1, wherein the updating the overlay comprises matching the overlay to an appearance of the device display within the environment.

3. The method of claim 1, comprising detecting an obstruction over the device display, wherein the updating the overlay comprises segmenting a portion of the overlay and adjusting an opacity of the overlay at the portion.

4. The method of claim 3, wherein the adjusting the opacity comprises making the portion transparent.

5. The method of claim 1, wherein the updating comprises changing a size and shape of the overlay as the device is moved within the environment.

6. The method of claim 1, wherein the generating the overlay is responsive to detecting light conditions affecting a viewability of the device display through the display of the immersive device.

7. The method of claim 1, wherein the updating the overlay comprises detecting light conditions affecting a viewability of the device display within the environment and updating the overlay to including the light conditions.

8. The method of claim 1, wherein the receiving the display information comprises receiving the display information from the device.

9. The method of claim 1, wherein the generating the overlay and the updating the overlay comprises utilizing gaze tracking and sensors within the immersive device to detect a location of a head of a user with respect to the location of the device within the environment.

10. The method of claim 1, wherein the generating the overlay and the updating the overlay is based upon user-selected preferences.

11. A system, the system comprising:
an immersive device comprising a display;
a device display of a device;
a processor;
a memory device that stores instructions that, when executed by the processor, causes the system to:
receive, at the immersive device, display information related to information being displayed on the device display that is within an environment being viewed through the display of the immersive device;
display, on the display of the immersive device, video corresponding to the environment, wherein the displaying comprises generating an overlay for the device display containing the information being displayed and positioning the overlay on the display of the immersive device at a location corresponding to a location of the device within the environment; and
update, the display on the immersive device, the overlay for the device display in real-time based upon information on the device display and characteristics of the device.

12. The system of claim 11, wherein the updating the overlay comprises matching the overlay to an appearance of the device display within the environment.

13. The system of claim 11, comprising detecting an obstruction over the device display, wherein the updating the overlay comprises segmenting a portion of the overlay and adjusting an opacity of the overlay at the portion.

14. The system of claim 13, wherein the adjusting the opacity comprises making the portion transparent.

15. The system of claim 11, wherein the updating comprises changing a size and shape of the overlay as the device is moved within the environment.

16. The system of claim 11, wherein the generating the overlay is responsive to detecting light conditions affecting a viewability of the device display through the display of the immersive device.

17. The system of claim 11, wherein the updating the overlay comprises detecting light conditions affecting a viewability of the device display within the environment and updating the overlay to including the light conditions.

18. The system of claim 11, wherein the receiving the display information comprises receiving the display information from the device.

19. The system of claim 11, wherein the generating the overlay and the updating the overlay comprises utilizing gaze tracking and sensors within the immersive device to detect a location of a head of a user with respect to the location of the device within the environment.

20. A product, the product comprising:
a computer-readable storage device that stores executable code that, when executed by a processor, causes the product to:
receive, at an immersive device, display information related to information being displayed on a device display that is within an environment being viewed through a display of the immersive device;
display, on the display of the immersive device, video corresponding to the environment, wherein the displaying comprises generating an overlay for the device display containing the information being displayed and positioning the overlay on the display of the immersive device at a location corresponding to a location of the device within the environment; and
update, the display on the immersive device, the overlay for the device display in real-time based upon information on the device display and characteristics of the device.
